(19) United States
(12) Patent Application Publication
(10) Pub. No.: US 2002/0165717 A1
(43) Pub. Date: Nov. 7, 2002

(54) Efficient method for information extraction

(76) Inventors: Robert P. Solmer, San Diego, CA (US); Christopher K. Harris, San Diego, CA (US); Mauritius A.R. Schmidtler, San Diego, CA (US); James W. Dolter, San Diego, CA (US)

Correspondence Address: Kate H. Murashige, Morrison & Foerster LLP, Suite 500, 3811 Valley Centre Drive, San Diego, CA, 92130-2332, US

(21) Appl. No.: 10/118,968

(22) Filed: Apr. 8, 2002

Related U.S. Application Data
(60) Provisional application No. 60/282,182, filed on Apr. 6, 2001.

(51) Int. Cl. G10L 15/00

(52) U.S. Cl. 704/256

(57) ABSTRACT

The invention provides a method and system for extracting information from text documents. A document intake module receives and stores a plurality of text documents for processing, an input format conversion module converts each document into a standard format for processing, an extraction module identifies and extracts desired information from each text document, and an output format conversion module converts the information extracted from each document into a standard output format. These modules operate simultaneously on multiple documents in a pipeline fashion so as to maximize the speed and efficiency of extracting information from the plurality of documents.

### BACKGROUND OF THE INVENTION

1. Field of the Invention

The present invention relates to the field of extraction of information from text data, documents or other sources (collectively referred to herein as “text documents” or “documents”).

2. Description of Related Art

Information extraction is concerned with identifying words and/or phrases of interest in text documents. A user formulates a query that is understandable to a computer which then searches the documents for words and/or phrases that match the user's criteria. When the documents are known in advance to be of a particular type (e.g., research papers or resumes), the search engine can take advantage of known properties typically found in such documents to further optimize the search process for maximum efficiency. For example, documents that may be categorized as resumes contain common properties such as: Name followed by Address followed by Phone Number (N→A→P), where N, A and P are states containing symbols specific to those states. The concept of states is discussed in further detail below.

Known information extraction techniques employ finite state machines (FSMs), also known as a networks, for approximating the structure of documents (e.g., states and transitions between states). A FSM can be deterministic, non-deterministic and/or probabilistic. The number of states and/or transitions adds to the complexity of a FSM and aids in its ability to accurately model more complex systems. However, the time and space complexity of FSM algorithms increases in proportion to the number of states and transitions between those states. Currently there are many methods for reducing the complexity of FSMs by reducing the number of states and/or transitions. This results in faster data processing and information extraction but less accuracy in the model since structural information is lost through the reduction of states and/or transitions.

### Hidden Markov Models (HMMs)

Techniques utilizing a specific type of FSM called hidden Markov models (HMMs) to extract information from known document types such as research papers, for example, are known in the art. Such techniques are described in, for example, McCallum et al., A Machine Learning Approach to Building Domain-Specific Search Engines, School of Computer Science, Carnegie Mellon University, 1999, the entirety of which is incorporated by reference herein. These information extraction approaches are based on HMM search techniques that are widely used for speech recognition and part-of-speech tagging. Such search techniques are discussed, for example, by L. R. Rabiner, A Tutorial On Hidden Markov Models and Selected Applications in Speech Recognition, Proceedings of the IEEE, 77(2):257-286, 1989, the entirety of which is incorporated by reference herein.

Generally, a HMM is a data structure having a finite set of states, each of which is associated with a possible multidimensional probability distribution. Transitions among the states are governed by a set of probabilities called transition probabilities. In a particular state, an outcome or observation can be generated, according to the associated probability distribution. It is only the outcome, not the state that is visible to an external observer and therefore states are “hidden” to the external observer—hence the name hidden Markov model.

Discrete output, first-order HMMs are composed of a set of states Q, which emit symbols from a discrete vocabulary Σ, and a set of transitions between states (q→q′). A common goal of search techniques that use HMMs is to recover a state sequence V(x|M) that has the highest probability of correctly matching an observed sequence of states x=x₁, x₂, . . . xₙ εΣ as calculated by:

V(x|M)=arg max II P(qₖ₋₁→qₖ)P(qₖ↑xₖ),

for k=1 to n, where M is the model, P(qₖ₋₁→qₖ) is the probability of transitioning between states q_{k-1 and} qₖ, and P(qₖ↑xₖ) is the probability of state qₖ emitting output symbol xₖ. It is well-known that this highest probability state sequence can be recovered using the Viterbi algorithm as described in A. J. Viterbi, Error Bounds for Convolutional Codes and an Asymtotically Optimum Decoding Algorithm, IEEE Transactions on Information Theory, IT-13:260-269, 1967, the entirety of which is incorporated herein by reference.

The Viterbi algorithm centers on computing the most likely partial observation sequences. Given an observation sequence O=o₁, o₂, . . . o_{T}, the variable vₜ(j) represents the probability that state j emitted the symbol oₜ, 1≦t ≦T. The algorithm then performs the following steps:

First initialize all v₁(j)=pⱼbⱼ (o₁).

Then recurse as follows:

vₜ₊₁(j)=bⱼ(oₜ₊₁)(max[iεQ]vₜ(i)aᵢⱼ)

When the calculation of V_{T}(j) is completed, the algorithm is finished, and the final state can be obtained from:

j*=arg max[jεQ]v_{T}(j)

Similarly the associated arg max can be stored at each stage in the computation to recover the Viterbi path, the most likely path through the HMM that most closely matches the document from which information is being extracted.

By taking the logarithm of the starting, transition and emission probabilities, all multiplications in the Viterbi algorithm can be replaced with additions, and the maximums can be replaced with minimums, as follows:

First, initialize all v₁(j)=sⱼ+Bⱼ (o₁).

Then recurse as follows:

vₜ₊₁(j)=Bⱼ(oₜ₊₁)+min[iεQ]Vₜ(i)+Aᵢⱼ)

When the calculation of V_{T}(j) is completed, the algorithm is finished, and the final state can be obtained from:

j*=arg min[jεQ]v_{T}(j)

where

Bⱼ=log bⱼ, Aᵢⱼ=log aᵢⱼ,

and

sⱼ=log of pⱼ.

In contrast to discrete output, first-order HMM data structures, Hierarchical HMMs (HHMMs) refer to HMMs having at least one state which constitutes an entire HMM itself, nested within the larger HMM. These types of states are referred to as HMM super states. Thus, HHMMs contain at least one HMM SuperState. FIG. 1 illustrates an exemplary structure of an HHMM 200 modeling a resume document type. As shown in FIG. 1, the HHMM 200 includes a top-level HMM 202 having HMM super states called Name 204 and Address 206, and a production state called Phone 208. At a next level down, a second-tier HMM 210 illustrates why the state AdName 204 is a super state. Within the super state Name 204, there is an entire HMM 212 having the following subsequence of states: First Name 214, Middle Name 216 and Last Name 218. Similarly, super state Address 206 constitutes an entire HMM 220 nested within the larger HHMM 202. As shown in FIG. 1, the nested HMM 220 includes a subsequence of states for Street Number 222, Street Name 224, Unit No. 226, City 228, State 230 and Zip 232. Thus, it is said that nested HMMs 210 and 220, each containing subsequences of states, are at a depth or level below the top-level HMM 202. If an HMM does not contain any states which are “superstates,” then that model is not a hierarchical model and is considered to be “flat.” Referring again to FIG. 1, HMMs 210, 212 and 220 are examples of “flat” HMMs. Thus, in order to “flatten” a HHMM into a single level HMM, each super state must be replaced with their nested subsequences of states, starting from the bottom-most level all the way up to the top-level HMM.

When modeling relatively complex document structures, Hierarchical HMMs provide advantages because they are typically simpler to view and understand when compared to standard HMMs. Because HHMMs have nested HMMs (otherwise referred to as sub-models) they are smaller and more compact and provide modeling at different levels or depths of detail. Additionally, the details of a sub-model are often irrelevant to the larger model. Therefore, sub-models can be trained independently of larger models and then “plugged in.” Furthermore, the same sub-model can be created and then used in a variety of HMMs. For example, a sub-model for proper names or phone numbers may be used in multiple HMMs such as IMMs (super states) for “Applicant's Contact Info” and “Reference Contact Info.” HHMMs are known in the art and those of ordinary skill in the art know how to create them and flatten them. For example, a discussion of HHMM's is provided in S. Fine, et al., “The Hierarchical Hidden Markov Model: Analysis and Applications, Institute of Computer Science and Center for Neural Computation, The Hebrew University, Jerusalem, Israel, the entirety of which is incorporated by reference herein.

Various types of HMM implementations are known in the art. A HMM state refers to an abstract base class for different kinds of HMM states which provides a specification for the behavior (e.g., function and data) for all the states. As discussed above in connection with FIG. 1, a HMM super state refers to a class of states representing an entire HMM which may or may not be part of a larger HMM. A HMM leaf state refers to a base class for all states which are not “super states” and provides a specification for the behavior of such states (e.g., function and data parameters). A HMM production state refers to a “classical” discrete output, first-order HMM state having no embedded states (i.e., it is not a super state) and containing one or more symbols (e.g., alphanumeric characters, entire words, etc.) in an “alphabet,” wherein each symbol (otherwise referred to as an element) is associated with its own output probability or “experience” count determined during the “training” of the HMM. The states classified as First Name 214, Middle Name 216 and Last Name 218, as illustrated in FIG. 1, are exemplary HMM production states. These states contain one or more symbols (e.g., Rich, Chris, John, etc.) in an alphabet, wherein the alphabet comprises all symbols experienced or encountered during training as well as “unknown” symbols to account for previously unencountered symbols in new documents. A more detailed discussion of the various types of HMM states mentioned above is provided in the S. Fine article incorporated by reference herein.

FIG. 2 illustrates a Unified Modeling Language (UML) diagram showing a class hierarchy data structure of the relationships between HMM states, HMM super states, HMM leaf states and HMM production states. Such UML diagrams are well-known and understood by those of ordinary skill in the art. As shown in FIG. 2, both HMM super states and HMM leaf states inherit the behavior of the HMM state base class. The HMM production states inherit the behavior of the HMM leaf state base class. Typically, all classes (e.g., super state, leaf state or production state) in an HMM state class tree have the following data members:

className: a string representing the identifying name of the state (e.g, Name, Address, Phone, etc.).

parent: a pointer to the model (super state) that this state is a member of.

rtid: the associated resource type ID number for this state.

experience: the number of examples this state was trained on.

start_state_count: the number of times this state was a “start” state during training of the model. This cannot be greater than the state's experience.

end_state_count: the number of times this state was an “end” state during training of the model.

In addition to the basic HMM state base class attributes above, super states have the following notable data members:

model: a list of states and transition probabilities.

classificationModel: the parameters for the statistical model that takes the length and Viterbi score as input and outputs the likelihood the document was generated by the HMM.

As discussed above, one of the distinguishing features of HMM production states is that they contain symbols from an alphabet, each having its own output probability or experience count. The alphabet for a HMM production state consists of strings referred to as tokens. Tokens typically have two parameters: type and word. The type is a tuple (e.g., finite set) which is used to group the tokens into categories, and the word is the actual text from the document. Each document which is used for training or from which information is to be extracted is first broken up into tokens by a lexer. The lexer then assigns each token to a particular state depending on the class tag associated with the state in which the token word is found. Various types of lexers, otherwise known as “tokenizers,” are well-known and may be created by those of ordinary skill in the art without undue experimentation. A detailed discussion of lexers and their functionality is provided by A. V. Aho, et al., Compilers: Principles, Techniques and Tools, Addison-Wesley Publ. Co. (1988), pp. 84-157, the entirety of which is incorporated by reference herein. Examples of some conventional token types are as follows:

CLASSSTART: A special token used in training to signify the start of a state's output.

CLASSEND: A special token used in training to signify the end of a state's output.

HTMLTAG: Represents all HTML tags.

HTMLESC: Represents all HTML escape sequences, like “&lt;”.

NUMERIC: Represents an integer; that is, a string of all numbers.

ALPHA: Represents any word.

OTHER: Represents all non-alphanumeric symbols; e.g., &, $, @, etc.

An example of a tokenizer's output for symbols found in a state class for “Name” might be as follows:

CLASSSTART Name

ALPHA Richard

ALPHA C

OTHER.

ALPHA Kim

CLASSEND Name

where (“Richard,” “C,” “.” and “Kim”) represent the set of symbols in the state class “Name.” As used herein the term “symbol” refers to any character, letter, word, number, value, punctuation mark, space or typographical symbol found in text documents.

If the state class “Name” is further refined into nested substates having subclasses “First Name,” “Middle Name” and “Last Name,” for example, the tokenizer's output would then be as follows:

CLASSSTART Name

CLASSSTART First Name

ALPHA Richard

CLASSEND First Name

CLASSSTART Middle Name

ALPHA C

OTHER.

CLASSEND Middle Name

CLASSSTART Last Name

ALPHA Kim

CLASSEND Last Name

CLASSEND Name

### Building HMMs

HMMs may be created either manually, whereby a human creates the states and transition rules, or by machine learning methods which involve processing a finite set of tagged training documents. “Tagging” is the process of labeling training documents to be used for creating an HMM. Labels or “tags” are placed in a training document to delimit where a particular state's output begins and ends. For example, <Tag> This sentence is tagged as being in the state Tag.<\Tag> Additionally, tags can be nested within one another. For example, in <Name><FirstName>Richard<\FirstName><LastName>\Kim<\Last Name><Name>, the “FirstName” and “LastName” tags are nested within the more general tag “Name.” Thus, the concept and purpose of tagging is simply to label text belonging to desired states. Various manual and automatic techniques for tagging documents are known in the art. For example, one can simply manually type a tag symbol before and after particular text to label that text as belonging to a particular state as indicated by the tag symbol.

As discussed above, HMMs may be used for extracting information from known document types such as research papers, for example, by creating a model comprising states and transitions between states, along with probabilities associated for each state and transition, as determined during training of the model. Each state is associated with a class that is desired for extraction such as title, author or affiliation. Each state contains class-specific words which are recovered during training using known documents containing known sequences of classes which have been tagged as described above. Each word in a state is associated with a distribution value depending on the number of times that word was encountered in a particular class field (e.g., title) during training. After training and creation of the HMM is completed, in order to label new text with classes, words from the new text are treated as observations and the most likely state sequence for each word is recovered from the model. The most likely state that contains a word is the class tag for that word. An illustrative example of a prior art HMM for extraction of information from documents believed to be research papers is shown in FIG. 3 which is taken from the McCallum article incorporated by reference herein.

### Merging

Immediately after all the states and transitions for each training document have been modeled in a HMM (i.e., training is complete), the HMM represents pure memorization of the content and structure of each training document. FIG. 4 illustrates a structural diagram of the HMM immediately after training has been completed using N training documents each having a random number of production states S having only one experience count. This HMM does not have enough experience to be useful in accepting new documents and is said to be too complex and specific. Thus, the HMM must be made more general and less complex so that it is capable of accepting new documents which are not identical to one of the training documents. In order to generalize the model, states must be merged together to create a model which is useful. Within a large model, there are typically many states representing the same class. The simplest form of merging is to combine states of the same class.

The merged models may be derived from training data in the following way. First, an HMM is built where each state only transitions to a single state that follows it. Then, the HMM is put through a series of state merges in order to generalize the model. First, “neighbor merging” or “horizontal merging” (referred to herein as “H-merging”) combines all states that share a unique transition and have the same class label. For example, all adjacent title states are merged into one title state which contains multiple words, each word having a percentage distribution value associated with it depending on its relative number of occurrences. As two or more states are merged, transition counts are preserved, introducing a self-loop or self-transition on the new merged state. FIG. 5 illustrates the H-merging of two adjacent states taken from a single training document, wherein both states have a class label “Title.” This H-merging forms a new merged state containing the tokens from both previously-adjacent states. Note the self-transition 500 having a transition count of 1 to preserve the original transition count that existed prior to merging.

The HMM may be further merged by vertically merging (“V-merging”) any two states having the same label and that can share transitions from or to a common state. The H-merged model is used as the starting point for the two multi-state models. Typically, manual merge decisions are made in an interactive manner to produce the H-merged model, and an automatic forward and backward V-merging procedure is then used to produce a vertically-merged model. Such automatic forward and backward merging software is well-known in the art and discussed in, for example, the McCallum article incorporated by reference herein. Transition probabilities of the merged models are recalculated using the transition counts that have been preserved during the state merging process. FIG. 6 illustrates the V-merging of two previously H-merged states having a class label “Title” and two states having a class label “Publisher” taken from two separate training documents. Note that transition counts are again maintained to calculate the new probability distribution functions for each new merged state and the transitions to and from each merged state. Both H-merging and V-merging are well-known in the art and discussed in, for example, the McCallum article. After an HMM has been merged as described above, it is now ready to extract information from new test documents.

One measure of model performance is word classification accuracy, which is the percentage of words that are emitted by a state with the same label as the words' true label or class (e.g., title). Another measure of model performance is word extraction speed, which is the amount of time it takes to find a highest probability sequence match or path (i.e., the “best path”) within the HMM that correctly tags words or phrases such that they are extracted from a test document. The processing time increases dramatically as the complexity of the HMM increases. The complexity of the HMM may be measured by the following formula:

(No. of States)×(No. of transitions)=“Complexity”

Thus, another benefit of merging states is that it reduces the number of states and transitions, thereby reducing the complexity of the HMM and increasing processing speed and efficiency of the information extraction. However, there is a danger of over-merging or over-generalizing the HMM, resulting in a loss of information about the original training documents such that the HMM no longer accurately reflects the structure (e.g., number and sequence of states and transitions between states) of the original training documents. While some generalization (e.g., merging) is needed to be useful in accepting new documents, as discussed above, too much generalization (e.g., over-merging) will adversely effect the accuracy of the HMM because too much structural information is lost. Thus, prior methods attempt to find a balance between complexity and generality in order to optimize the HMM to accurately extract information from text documents while still performing this process in a reasonably fast and efficient manner.

Prior methods and systems, however, have not been able to provide both a high level of accuracy and high processing speed and efficiency. As discussed above, there is a trade off between these two competing interests resulting in a sacrifice of one to improve the other. Thus, there exists a need for an improved method and system for maximizing both processing speed and accuracy of the information extraction process.

Additionally, prior methods and systems require new text documents, from which information is to be extracted, to be in a particular format, such as HTML, XML or text file formats, for example. Because many different types of document formats exist, there exists a need for a method and system that can accept and process new text documents in a plurality of formats.

### SUMMARY OF THE INVENTION

The invention addresses the above and other needs by providing a method and system for extracting information from text documents, which may be in any one of a plurality of formats, wherein each received text document is converted into a standard format for information extraction and, thereafter, the extracted information is provided in a standard output format.

In one embodiment of the invention, a system for extracting information from text documents includes a document intake module for receiving and storing a plurality of text documents for processing, an input format conversion module for converting each document into a standard format for processing, an extraction module for identifying and extracting desired information from each text document, and an output format conversion module for converting the information extracted from each document into a standard output format. In a further embodiment, these modules operate simultaneously on multiple documents in a pipeline fashion so as to maximize the speed and efficiency of extracting information from the plurality of documents.

In another embodiment, a system for extracting information includes an extraction module which performs both H-merging and V-merging to reduce the complexity of HMM's. In this embodiment, the extraction module further merges repeating sequences of states such as “N-A-P-N-A-P,” for example, to further reduce the size of the HMM, where N, A and P each represents a state class such as Name (N), Address (A) and Phone Number (P), for example. This merging of repeating sequences of states is referred to herein as “ESS-merging.”

Although performing H-merging, V-merging and ESS-merging may result in over-merging and a substantial loss in structural information by the HMM, in a preferred embodiment, the extraction module compensates for this loss in structural information by performing a separate “confidence score” analysis for each text document by determining the differences (e.g., edit distance) between a best path through the HMM for each text document, from which information is being extracted, and each training document. The best path is compared to each training document and an “average” edit distance between the best path and the set of training documents is determined. This average edit distance, which is explained in further detail below, is then used to calculate the confidence score (also explained in further detail below) for each best path and provides further information as to the accuracy of the information extracted from each text document.

In a further embodiment, the HMM is a hierarchical HMM (HHMM) and the edit distance between a best path (representative of a text document) and a training document is calculated such that edit distance values associated with subsequences of states within the best path are scaled by a specified cost factor, depending on a depth or level of the subsequences within the best path. As used herein, the term “HMM” refers to both first-order HMM data structures and HHMM data structures, while “HHMM” refers only to hierarchical HMM data structures.

In another embodiment, HMM states are modeled with non-exponential length distributions so as to allow their probability length distributions to be changed dynamically during information extraction. If a first state's best transition was from itself, its self-transition probability is adjusted to (1−cdf(t+1))/(1−cdf(t)) and all other outgoing transitions from the first state are scaled by (cdf(t+1)−cdf(t))/(1−cdf(t)). If the first state is transitioned to by another state, its self-transition probability is reset to its original value of ((1−cdf(1))/(1−cdf(0)), where cdf is the cumulative probability distribution function for the first state's length distribution, and t is the number of symbols emitted by the first state in the best path.

### BRIEF DESCRIPTION OF THE DRAWINGS

FIG. 1 illustrates an example of a hierarchical HMM structure.

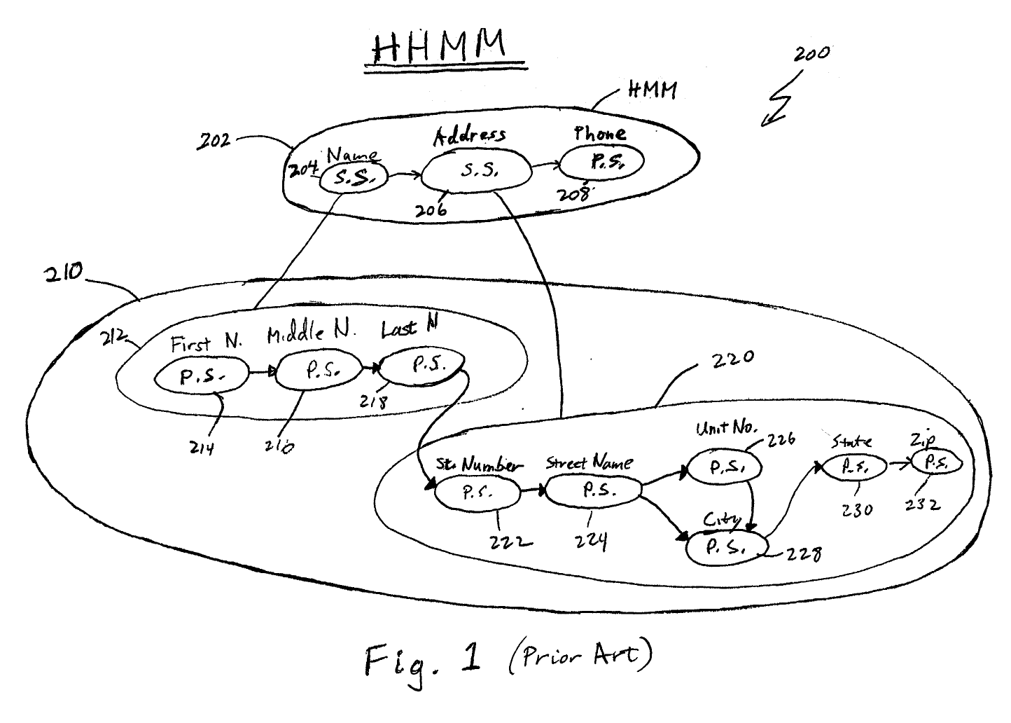

FIG. 2 illustrates a UML diagram showing the relationship between various exemplary HMM state classes.

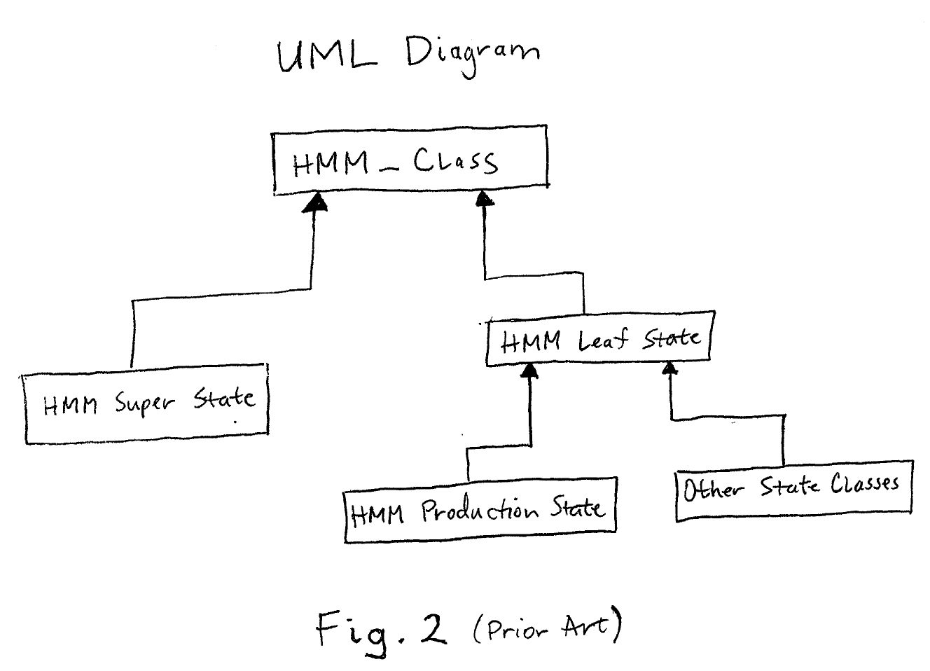

FIG. 3 illustrates an exemplary HMM trained to extract information from research papers.

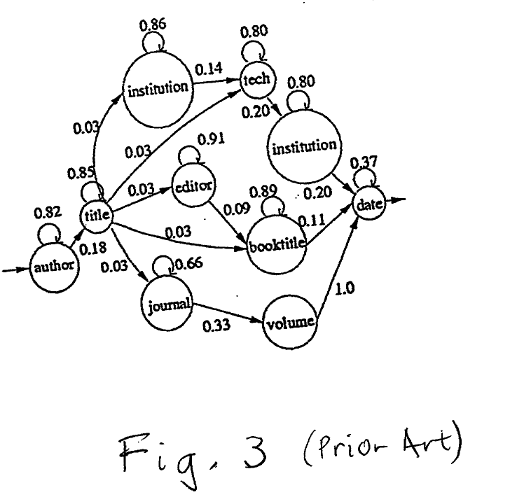

FIG. 4 illustrates an exemplary HMM structure immediately after training is completed and before any merging of states.

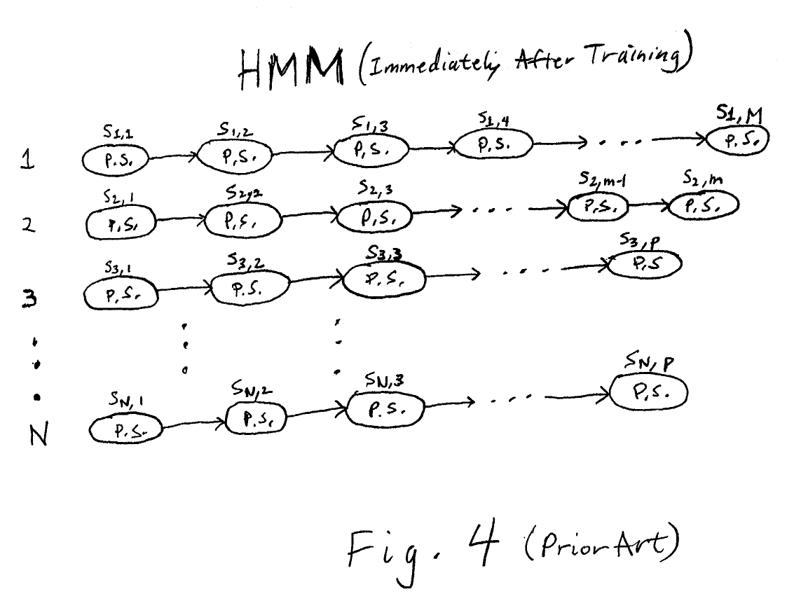

FIG. 5 illustrates an example of the H-merging process.

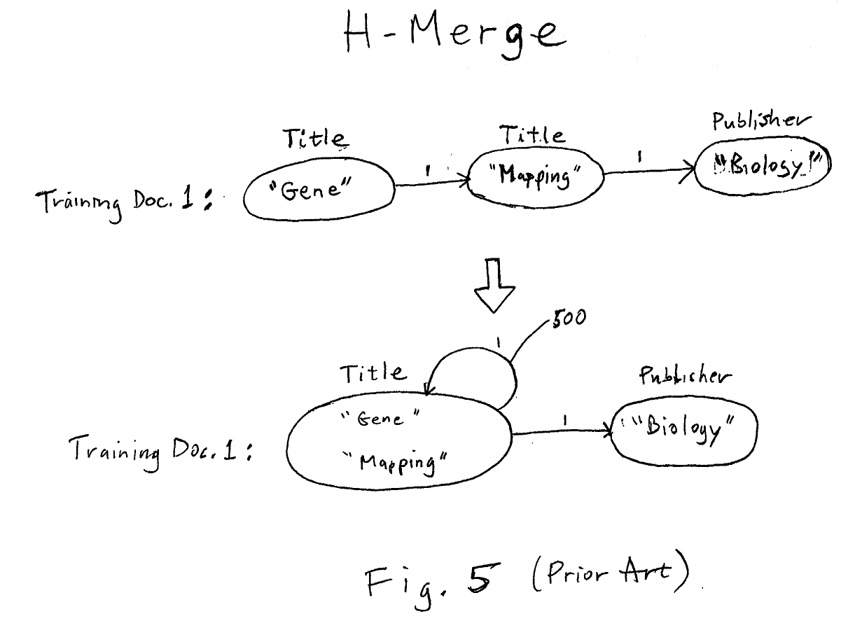

FIG. 6 illustrates an example of the V-merging process.

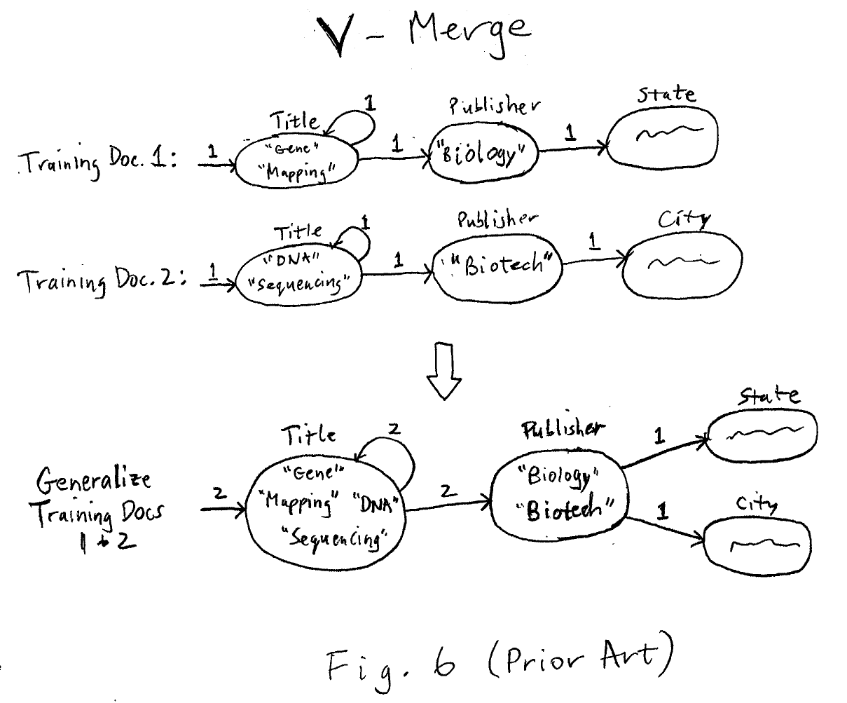

FIG. 7 illustrates a block diagram of a system for extracting information from a plurality of text documents, in accordance with one embodiment of the invention.

FIG. 8 illustrates a sequence diagram for a data and control file management protocol implemented by the system of FIG. 7 in accordance with one embodiment of the invention.

FIG. 9 illustrates an example of ESS-merging in accordance with one embodiment of the invention.

### DETAILED DESCRIPTION OF THE PREFERRED EMBODIMENTS

The invention, in accordance with various preferred embodiments, is described in detail below with reference to the figures, wherein like elements are referenced with like numerals throughout.

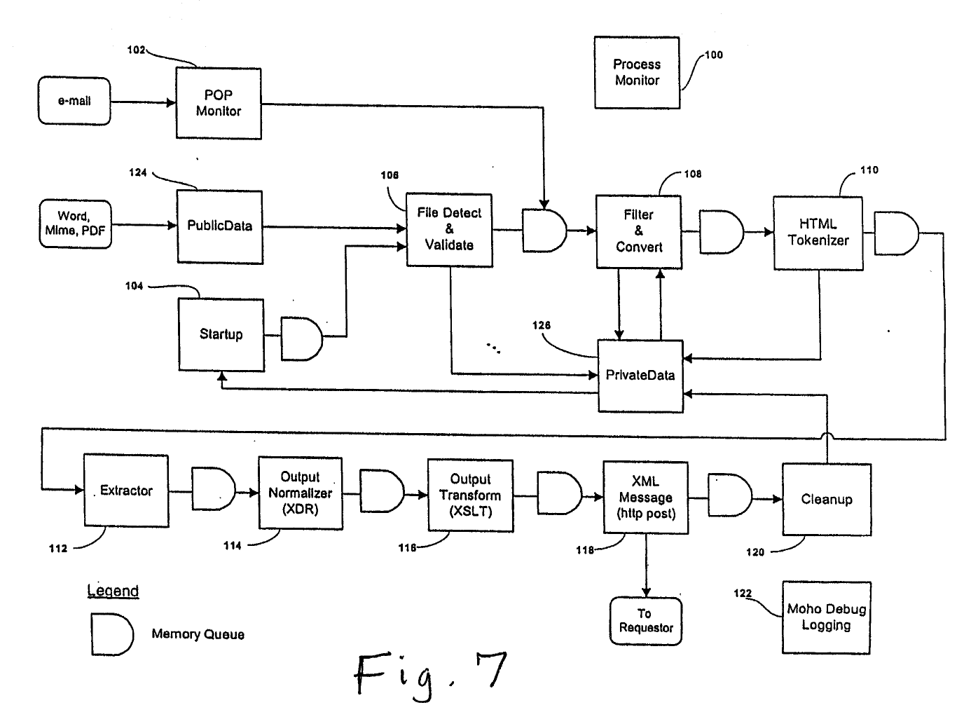

FIG. 7 is a functional block diagram of a system 10 for extracting information from text documents, in accordance with one embodiment of the present invention. The system 10 includes a Process Monitor 100 which oversees and monitors the processes of the individual components or subsystems of the system 10. The Process Monitor 100 runs as a Windows NT® service, writes to NT event logs and monitors a main thread of the system 10. The main thread comprises the following components: post office protocol (POP) Monitor 102, Startup 104, File Detection and Validation 106, Filter and Converter 108, HTML Tokenizer 110, Extractor 112, Output Normalizer (XDR) 114, Output Transform (XSLT) 116, XML Message 118, Cleanup 120 and Moho Debug Logging 122. All of the components of the main thread are interconnected through memory queues 128 which each serve as a repository of incoming jobs for each subsequent component in the main thread. In this way the components of the main thread can process documents at a rate that is independent of other components in the main thread in a pipeline fashion. In the event that any component in the main thread ceases processing (e.g., “crashes”), the Process Monitor 100 detects this and re-initiates processing in the main thread from the point or state just prior to when the main thread ceased processing. Such monitoring and re-start programs are well-known in the art.

The POP Monitor 102 periodically monitors new incoming messages, deletes old messages and is the entry point for all documents that are submitted by e-mail. The POP Monitor 202 is well-known software. For example, any email client software such as Microsoft Outlook® contains software for performing POP monitoring functions.

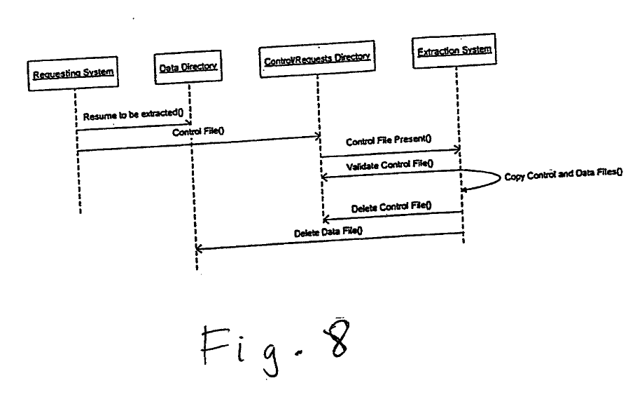

The PublicData unit 124 and PrivateData unit 126 are two basic directory structures for processing and storing input files. The PublicData unit 124 provides a public input data storage location where new documents are delivered along with associated control files that control how the documents will be processed. The PublicData unit 124 can accept documents in any standard text format such as Microsoft Word, MIME, PDF and the like. The PrivateData unit 126 provides a private data storage location used by the Extractor 112 during the process of extraction. The File and Detection component 106 monitors a control file directory (e.g., PrivateData unit 124), validates control file structure, checks for referenced data files, copies data files to internal directories such as PrivateData unit 126, creates processing control files and deletes old document control and data files. FIG. 8 illustrates a sequence diagram for data and control file management in accordance with one embodiment of the invention.

The Startup component 104 operates in conjunction with the Process monitor 100 and, when a system “crash” occurs, the Startup component 104 checks for any remaining data resulting from previous incomplete processes. As shown in FIG. 7, the Startup component 104 receives this data and a processing control file, which tracks the status of documents through the main thread, from the PrivateData unit 126. The Startup component 104 then re-queues document data for re-processing at a stage in the main thread pipeline where it existed just prior to the occurrence of the system “crash.” Startup component 104 is well-known software that may be easily implemented by those of ordinary skill in the art.

The Filter and Converter component 108 detects file types, initiates converter threads to convert received data files to a standard format, such as text/HTML/MIME parsings. The Filter and Converter component 108 also creates new control and data files and re-queues these files for further processing by the remaining components in the main thread.

The HTML Tokenizer component 110 creates tokens for each piece of HTML data used as input for the Extractor 112. Such tokenizers, also referred to as lexers, are well-known in the art.

As explained in further detail below, in a preferred embodiment, the Extractor component 112 extracts data file properties, calculates the Confidence Score for the data file, and outputs raw extended markup language (XML) data that is non-XML-data reduced (XDR) compliant.

The Output Normalizer component (XDR) 114 converts raw XML formatted data to XDR compliant data. The Output Transform component (XSLT) 116 converts the data file to a desired end-user-compliant format. The XML Message component 118 then transmits the formatted extracted information to a user configurable URL. Exemplary XML control file and output file formats are illustrated and described in the Specification for the Mohomine Resume Extraction System, attached hereto as Appendix A.

The Cleanup component 120 clears all directories of temporary and work files that were created during a previous extraction process and the Debug Logging component 122 performs the internal processes for writing and administering debugging information. These are both standard and well-known processes in the computer software field.

Further details of a novel information extraction process, in accordance with one preferred embodiment of the invention, are now provided below.

As discussed above, the Extractor component 112 (FIG. 7) carries out the extraction process, that is, the identification of desired information from data files and documents (referred to herein as “text documents”) such as resumes. In one embodiment, the extraction process is carried out according to trained models that are constructed independently of the present invention. As used herein, the term “trained model” refers to a set of pre-built instructions or paths which may be implemented as HMMs or HHMMs as described above. The Extractor 112 utilizes several functions to provide efficiency in the extraction process.

As described above, finite state machines such as HMMs or HHMMs can statistically model known types of documents such as resumes or research papers, for example, by formulating a model of states and transitions between states, along with probabilities associated with each state and transition. As also discussed above, the number of states and/or transitions adds to the complexity of the HMM and aids in its ability to accurately model more complex systems. However, the time and space complexity of HMM algorithms increases in proportion to the number of states and transitions between those states.

### ESS-Merging

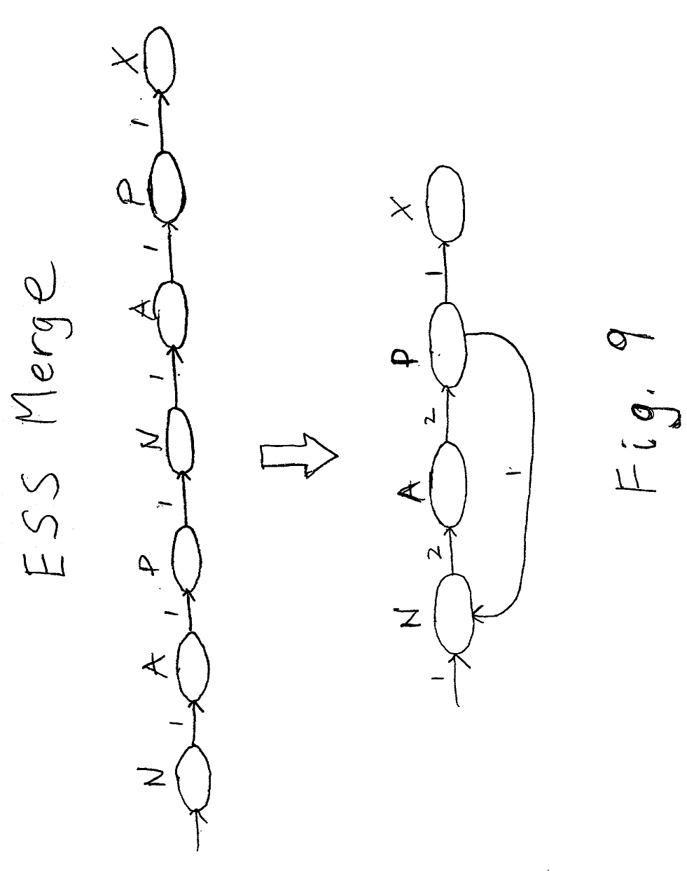

In a further embodiment, HMMs are reduced in size and made more generalized by merging repeated sequences of states such as A-B-C-A-B-C. In order to further reduce the complexity of HMMs, in one preferred embodiment of the invention, in addition to H-merging and V-merging, a repeat sequence merging algorithm, otherwise referred to herein as ESS-merging, is performed to further reduce the number of states and transitions in the HMM. As illustrated in FIG. 9, ESS merging involves merging repeating sequences of states such as N-A-P-N-A-P, where N, A, and P represent state classes such as Name (N), Address (A) or Phone No. (P) class types, for example. This additional merging provides for increased processing speed and, hence, faster information extraction. Although this extensive merging leads to a less accurate model, since structural information is lost through the reduction of states and/or transitions, as explained in further detail below, the accuracy and reliability of the information extracted from each document is supplemented by a confidence score calculated for each document. In a preferred embodiment, the process of calculating this confidence score occurs externally and independently of the HMM extraction process.

In another preferred embodiment, hierarchical HMMs are used for constructing models. Once the models are completed the models are flattened for greater speed and efficiency in the simulation. As discussed above, hierarchical HMMs are much easier to conceptualize and manipulate than large flat HMMs. They also allow for simple reuse of common model components across the model. The drawback is that there are no fast algorithms analogous to Viterbi for hierarchical HMMs. However, hierarchical HMMs can be flattened after construction is completed to create a simple HMM that can be used with conventional HMM algorithms like Viterbi and “forward-backward” algorithms that are well-known in the art.

### Length Distributions

In a preferred embodiment of the invention, HMM states with normal length distributions are utilized as trained finite state machines for information extraction. One benefit of HMMs is that HMM transition probabilities can be changed dynamically during Viterbi algorithm processing when the length of a state's output is modeled as a normal distribution, or any distribution, other than an exponential distribution. After each token in a document is processed, all transitions are changed to reflect the number of symbols each state has emitted as part of the best path. If a state's best transition was from itself, its self-transition probability is adjusted to (1−cdf(t+1) /(1−cdf(t)) and all other outgoing transitions are scaled by (cdf(t+1)−cdf(t))/(1−cdf(t)), where cdf is the cumulative probability distribution function for the state's length distribution.

The above equations are derived in accordance with well-known principles of statistics. As is known in the art, the length of a state's output is the number of symbols it emits before a transition to another state. Each state has a probability distribution function governing its length that is determined by the changes in the value of its self-transition probability. Length distributions may be exponential, normal or log normal. In a preferred embodiment, a normal length distribution is used. The cumulative probability distribution function (cdf) of a normal length distribution is governed by the following formula:

(erf((t−μ)/σ√2)+1)/2

where erf is the standard error function, μ is the mean and σ is the standard deviation of the distribution.

While running the Viterbi algorithm, the number of symbols emitted by each state can be counted for the best path from the start to each state. If a state has emitted t symbols in a row, the probability it will also emit the t+1 symbol is equal to:

P(t+1>|x|>t∥x|>t)

and the probability it will not emit symbol t+1 is equal to:

P(|x|>t+1||x|>t)

We make use of the cumulative probability distribution function (cdf) for the length of the state to calculate the above probability length distribution values. Under standard principles of statistics, the following relationships are known:

P(|x|>t)=1−cdf(t)

P(|x|>t+1)=1−cdf(t+1)

P(|x|>t+1∥x|>t)=(1−cdf(t+1))/(1−cdf(t))

P(t+1>|x|>t∥x|>t)=(cdf(t+1)−cdf(t))/(1−cdf(t))*

*because

(1−cdf(t))−(1−cdf(t+1))=cdf(t+1)−cdf(t)

Each time a state emits another symbol, we recalculate all its transition probabilities. Its self-transition probability is set to:

(1−cdf(t+1))/(1−cdf(t))

All other transitions are scaled by:

(cdf(t+1)−cdf(t))/(1−cdf(t))

When a state is transitioned to by another state, its self-transition probability is reset to its original value of (1−cdf(1))/(1−cdf(0)).

In a preferred embodiment, the above-described transition probabilities are calculated by program files within the program source code attached hereto as Appendix B. These transition probability calculations are performed by a program file named “hmmvit.cpp”, at lines 820-859 (see pp. 66-67 of Appendix B) and another file named “hmmproduction.cpp” at lines 917-934 and 959-979 (see pp. 47-48 of Appendix B).

### Confidence Score

As discussed above, once a HMM has been constructed in accordance with the preferred methods of the invention discussed above, the HMM may now be utilized to extract desired information from text documents. However, because the HMM of the present invention is intentionally over-merged to maximize processing speed, structural information of the training documents is lost, leading to a decrease in accuracy and reliability that the extracted information is what it purports to be.

In a preferred embodiment, in order to compensate for this decrease in reliability, the present invention provides a method and system to regain some of the lost structural information while still maintaining a small HMM. This is achieved by comparing extracted state sequences for each text document to the state sequences for each training document (note that this process is external to the HMM) and, thereafter, using the computationally efficient edit distance algorithm to compute a confidence score for each text document.

The concept of edit distance is well-known in the art. As an illustrative example, consider the words “computer” and “commuter.” These words are very similar and a change of just one letter, “p” to “m,” will change the first word into the second. The word “sport” can be changed into “spot” by the deletion of the “r,” or equivalently, “spot” can be changed into “sport” by the insertion of“r.”

The edit distance of two strings, s1 and s2, is defined as the minimum number of point mutations required to change s1 into s2, where a point mutation is one of:

change a letter,

insert a letter or

delete a letter

The following recurrence relations define the edit distance, d(s1,s2), of two strings s1 and s2:

d(″, ″)=0

d(s, ″)=d(″, s)=|s|—i.e. length of s

d(s1+ch1, s2+ch2)=min of:

1. d (s1, s2)+C₁₃ rep (C₁₃ rep=0, if ch1=ch2);

2. d(s1+ch1, s2)+C₁₃ del; or

3. d(s1, s2+ch2)+C₁₃ ins

where C₁₃ rep, C₁₃ del and C₁₃ ins represent the “cost” of replacing, deleting or inserting symbols, respectively, to make s1+ch1 the same as s2+ch2. The first two rules above are obviously true, so it is only necessary to consider the last one. Here, neither string is the empty string, so each has a last character, ch1 and ch2 respectively. Somehow, ch1 and ch2 have to be explained in an edit of s1+ch1 into s2+ch2. If ch1 equals ch2, they can be matched for no penalty, i.e. 0, and the overall edit distance is d(s1,s2). If ch1 differs from ch2, then ch1 could be changed into ch2, e.g., penalty or cost of 1, giving an overall cost d(s1,s2)+1. Another possibility is to delete ch1 and edit s1 into s2+ch2, giving an overall cost of d(s1,s2+ch2)+1. The last possibility is to edit s1+ch1 into s2 and then insert ch2, giving an overall cost of d(s1+ch1,s2)+1. There are no other alternatives. We take the least expensive, i.e., minimum cost of these alternatives.

As mentioned above, the concept of edit distance is well-known in the art and described in greater detail in, for example, V. I. Levenshtein, Binary Codes Capable of Correcting Deletions, Insertions and Reversals, Doklady Akedemii Nauk USSR 163(4), pp. 845-848 (1965), the entirety of which is incorporated by reference herein. Further details concerning edit distance may be found in other articles. For example, E. Ukkonen, On Approximate String Matching, Proc. Int. Conf. on Foundations of Comp. Theory, Springer-Verlag, LNCS 158, pp. 487-495, (1983), the entirety of which is incorporated by reference herein, discloses an algorithm with a worst case time complexity O(n*d), and an average complexity O(n+d²), where n is the length of the strings, and d is their edit distance.

In a preferred embodiment of the present invention, the edit distance function is utilized as follows. Let the set of sequences of states that an FSM (e.g., EMM) can model, either on a state-by-state basis or on a transition-by-transition basis, be S=(s₁, S₂, . . . , sₙ). This collection of sequences can either be explicitly constructed by hand or sampled from example data used to construct the FSM. S can be compacted into S′ where every element in S′ is a <frequency, unique sequence> pair. Thus S′ consists of all unique sequence elements in S, along with the number of times that sequence appeared in S. This is only a small optimization in storing S, and does not change the nature of the rest of the procedure.

As mentioned above, in a preferred embodiment, the FSM is an HMM that is constructed using a plurality of training documents which have been tagged with desired state classes. In one embodiment, certain states can be favored to be more important than others in recovering the important parts of a document during extraction. This can be accomplished by altering the edit distance “costs” associated with each insert, delete, or replace operation in a memoization table based on the states that are being considered at each step in the dynamic programming process.

If the HMM or the document attributes being modeled are hierarchical in nature (note that either one of these conditions can be true, both are not required) the above paradigm of favoring certain states over others can be extended further. To extend the application simply enable S or S′ to hold not only states, but subsequences of states. The edit distance between two subsequences is defined as the edit distance between those two nested subsequences. Additionally a useful practical adjustment is to modify this recursive edit distance application by only examining differences up to some fixed depth d. By adjusting d one can adjust the generality vs. specificity that the document sequences in S are remembered. A further extension, in accordance with another preferred embodiment, is to weight each depth by some multiplicative cost C(d). This is implemented by redefining the distance between two sequences to be the edit distance between their subsequences multiplied by the cost C(d). Therefore one can force the algorithm to pay attention to particular levels of the sequence lists such as the very broad top level, the very narrow lowest levels, or a smooth combination of the two. If one sets C(d)=0.5power(d), for example, then a sequence with two nesting depths will calculate it's total cost to be 0.5*(edit distance of subsequence level 1)+0.25*(edit distance of all subsequences in level 2)+0.125*(edit distance of all subsequences in level 3).

In a preferred embodiment of the invention, the edit distance between a best path sequence p through an FSM and each sequence of states sᵢ in S is calculated, where sᵢ is a sequence of states for training document i and S represents the set of sequences S=(s₁, s₂, . . . sₙ), for i=1 to n, where n=the number of training documents used to train the FSM. After calculating the edit distance between p and each sequence sᵢ, an “average edit distance” between p and the set S may be calculated by summing each of the edit distances between p and sᵢ (i=1 to n) and dividing by n.

As is easily verifiable mathematically, the intersection between p and a sequence sᵢ is provided by the following equation:

|Iᵢ|=((|p|+|sᵢ|)−(edit distance))/2

where |p| and |sᵢ| is the number of states in p and sᵢ respectively. In order to calculate an “average intersection” between p and the entire set S, the following formula can be used:

|I_{avg}|=((|p|+avg|sᵢ|))−(avg. edit distance))/2

where avg|sᵢ| is the average number of states in sequences sᵢ in the set S and “avg. edit distance” is the average edit distance between p and the set S. Exemplary source code for calculating |I_{avg}| is illustrated in the program file “hrnmstructconf.cpp” at lines 135-147 of the program source code attached hereto as Appendix B. In a preferred embodiment, this average intersection value represents a measure of similarity between p and the set of training documents S. As described in further detail below, this average intersection is then used to calculate a confidence score (otherwise referred to as “fitness value” or “fval”) based on the notion that the more p looks like the training documents, the more likely that p is the same type of document as the training documents (e.g., a resume).

In another embodiment, the average intersection, or measure of similarity, between p and S, may be calculated as follows:

Procedure intersection with Sequence Set (p, S):

1. totalIntersection←0

2. For each element sᵢ in S

2.1 Calculate the edit distance between p and sᵢ. In a preferred embodiment, the function of calculating edit distance between p and sᵢ is called by a program file named “hmmstructconf.cpp” at line 132 (see p. 17 of Appendix B) and carried out by a program named “structtree.hpp” at lines 446-473 of the program source code attached hereto as Appendix B (see p. 13). As discussed above, the intersection between p and sᵢ may be derived from the edit distance between p and sᵢ.

2.2 totalIntersection←totalIntersection+intersection

3. I_{avg}←totalIntersection/|S|, where |S| is the number of elements sᵢ in S.

4. return I_{avg}

This procedure can be thought of as finding the intersection between the specific path p, chosen by the FSM, and the average path of FSM sequences in S. While the average path of S does not exist explicitly, the intersection of p with the average path is obtained implicitly by averaging the intersections of p with all paths in S and dividing by the number of paths.

Following the above approach, the following procedure uses this similarity measure to calculate the precision, recall and confidence score (F-value) of some path p through the FSM in relation to the “average set” derived from S.

Procedure calcFValue(intersectionSize, p, S):

1. precision=I_{avg}/|p|

2. recall=I_{avg}/(avg|sᵢ|)

3. fval←2/(1/precision+1/recall)

4. return fval

where |p| equals the number of states in p and avg|sᵢ| equals the average number of states in sᵢ, for i=1 to n. This confidence score (fval) can be used to estimate the fitness of p given the data seen to generate S within the context of structure alone (i.e., sequence of states as opposed to word values). Combined with the output of the FSM itself, there is obtained an enhanced estimate of p. If p is chosen using the Viterbi or a forward probability calculation for example, then combining this confidence score (fval) with the output of the path choosing algorithm (Viterbi score, likelihood of the forward probability, etc.) one can obtain an enhanced estimate for the fitness of p.

In a preferred embodiment, the calculations for “precision,” “recall” and “fval” as described above, are implemented within a program file named “hmmstructconf.cpp” at lines 158-167 of the source code attached hereto as Appendix B (see p. 18). Those of ordinary skill in the art will appreciate that the exemplary source code and the preceding disclosure is a single example of how to employ the distance from p to S to better estimate the fitness of p. One can logically extend these concepts to other fitness measures that can also be combined with the FSM method.

Various preferred embodiments of the invention have been described above. However, it is understood that these various embodiments are exemplary only and should not limit the scope of the invention as recited in the claims below. It is also understood that one of ordinary skill in the art would able to design and implement, without undue experimentation, some or all of the components utilized by the method and system of the present invention as purely executable software, or as hardware components (e.g. ASICs, programmable logic devices or arrays, etc.), or as firmware, or as any combination of these implementations. As used herein, the term “module” refers to any one of these components or any combination of components for performing a specified function, wherein each component or combination of components may be constructed or created in accordance with any one of the above implementations. Additionally, it is readily understood by those of ordinary skill in the art that any one or any combination of the above modules may be stored as computer-executable instructions in one or more computer-readable mediums (e.g., CD ROMs, floppy disks, hard drives, RAMs, ROMs, flash memory, etc.).

Furthermore, it is readily understood by those of ordinary skill in the art that the types of documents, state classes, tokens, etc. described above are exemplary only and that various other types of documents, state classes, tokens, etc. may be specified in accordance with the principles and techniques of the present invention depending on the type of information desired to be extracted. In sum, various modifications of the preferred embodiments described above can be implemented by those of ordinary skill in the art, without undue experimentation. These various modifications are contemplated to be within the spirit and scope of the invention as set forth in the claims below.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A system for extracting information from text documents, comprising:
an input module for receiving a plurality of text documents for information extraction, wherein said plurality of documents may be formatted in accordance with any one of a plurality of formats;
an input conversion module for converting said plurality of text documents into a single format for processing;
a tokenizer module for generating and assigning tokens to symbols contained in said plurality of text documents;
an extraction module for receiving said tokens from said tokenizer module and extracting desired information from each of said plurality of text documents;
an output conversion module for converting said extracted information into a single output format; and
an output module for outputting said converted extracted information, wherein each of the above modules operate simultaneous and independently of one another so as to process said plurality of text documents in a pipeline fashion.

2. The system of claim 1 wherein said extraction module finds a best path sequence of states in a HMM, wherein said HMM is trained using a plurality of training documents each having a sequence of tagged states, and wherein said information is extracted from said plurality of text documents based on a best path sequence of states provided by said HMM for each of said plurality of text documents.

3. The system of claim 2 wherein said extraction module calculates a confidence score for information extracted from at least one of said plurality of text documents, wherein said confidence score is based on a measure of similarity between said best path sequence of states and at least one of said sequence of tagged states from at least one of said plurality of training documents.

4. The system of claim 3 wherein said measure of similarity is based in part on an edit distance between said best path sequence of states and at least one of said sequence of tagged states from at least one of said plurality of training documents.

5. The system of claim 3 wherein said HMM is a hierarchical HMM (HHMM) comprising at least one subsequence of states within at least one of said states in said best path sequence of states and said confidence score is calculated using values of edit distance between said best path sequence of states, including said at least one subsequence of states, and said at least one sequence of tagged states, wherein said edit distance value associated with said at least one subsequence of states is scaled by a specified cost factor.

6. The system of claim 2 wherein said HMM comprises at least one merged state formed by V-merging, at least one merged stated formed by H-merging, and at least one merged sequence of states formed by ESS-merging.

7. The system of claim 2 wherein said HMM states are modeled with non-exponential length distributions and said extraction module further dynamically changes probability length distributions of said HMM states during information extraction, wherein if a first state's best transition was from itself, its self-transition probability is adjusted to (1−cdf(t+1))/(1−cdf(t)) and all other outgoing transitions from said first state are scaled by (cdf(t+1)−cdf(t))/(1−cdf(t)), and if said first state is transitioned to by another state, its self-transition probability is reset to its original value of (1−cdf(1))/(1−cdf(0)), where cdf is the cumulative probability distribution function for said first state's length distribution, and t is the number of symbols emitted by said first state in said best path.

8. The system of claim 1 further comprising:
a process monitor for monitoring the processes of each of said modules recited in claim 1 and detecting if one or more of said modules ceases to function;
a startup module for re-queuing data for reprocessing by one or more of said modules, in accordance with the status of said one or more modules prior to when it ceased functioning, and restarting said one or more modules to reprocess said re-queued data; and
a data storage unit for storing data control files and said data.

9. The system of claim 1 wherein said input module comprises:
an input data storage unit for storing said plurality of text documents and at least one control file associated with said plurality of text documents; and
a file detection and validation module for processing said at least one control file so as to validate its control file structure and check for at least one referenced data file containing data from at least one of said plurality of text documents, wherein said file detection and validation module further copies said at least one data file to a second data storage unit, creates at least one processing control file and, thereafter, deletes said plurality of text documents and said at least one control file from said input data storage unit.

10. The system of claim 9 wherein said input conversion module comprises a filter and converter module for detecting a file type for said at least one data file, initiating appropriate conversion routines for said at least one data file depending on said detected file type so as to convert said at least one data file into a standard format, and creating said at least one processing control file and at least one new data file, in accordance with said standard format, for further processing by said system.

11. The system of claim 1 wherein said output conversion module comprises:
an output normalizer module for converting said extracted information to a XDR-compliant data format: and
an output transform module for converting said XDR-compliant data to a desired end-user-compliant format.

12. A method of extracting information from a plurality of text documents, comprising the acts of:
receiving a plurality of text documents for information extraction, wherein said plurality of documents may be formatted in accordance with any one of a plurality of formats;
converting said plurality of text documents into a single format for processing;
generating and assigning tokens to symbols contained in said plurality of text documents;
extracting desired information from each of said plurality of text documents based in part on said token assignments;
converting said extracted information into a single output format; and
outputting the converted information, wherein each of the above acts are performed simultaneous and independently of one another so as to process said plurality of text documents in a pipeline fashion.

13. The method of claim 12 wherein said act of extracting comprises finding a best path sequence of states in a HMM, where said HMM is trained using a plurality of training documents each having a sequence of tagged states, and wherein said information is extracted from said plurality of text documents based on said best path sequence of states provided by said HMM for each of said plurality of text documents.

14. The method of claim 13 wherein said act of extracting further comprises calculating a confidence score for information extracted from at least one of said plurality of text documents, wherein said confidence score is based on a measure of similarity between said best path sequence of states and at least one of said sequence of tagged states from at least one of said plurality of training documents.

15. The method of claim 14 wherein said measure of similarity is based in part on an edit distance between said best path sequence of states and at least one of said sequence of tagged states from at least one of said plurality of training documents.

16. The method of claim 14 wherein said HMM is a hierarchical HMM (HHMM) comprising at least one subsequence of states within at least one of said states in said best path sequence of states and said confidence score is calculated using values of edit distance between said best path sequence of states, including said at least one subsequence of states, and said at least one sequence of tagged states, wherein said edit distance value associated with said at least one subsequence of states is scaled by a specified cost factor.

17. The method of claim 13 wherein said HMM comprises at least one merged state formed by V-merging, at least one merged stated formed by H-merging, and at least one merged sequence of states formed by ESS-merging.

18. The method of claim 13 wherein said HMM states are modeled with non-exponential length distributions and said act of extracting further comprises dynamically changing probability length distributions for said HMM states during information extraction, wherein if a first state's best transition was from itself, its self-transition probability is adjusted to (1−cdf(t+1))/(1−cdf(t)) and all other outgoing transitions from said first state are scaled by (cdf(t+1)−cdf(t))/(1−cdf(t)), and if said first state is transitioned to by another state, its self-transition probability is reset to its original value of (1−cdf(1))/(1−cdf(0)), where cdf is the cumulative probability distribution function for said first state's length distribution, and t is the number of symbols emitted by said first state in said best path.

19. The method of claim 12 further comprising:
monitoring the performance of each of said acts recited in claim 12 and detecting if one or more of said acts ceases to perform prematurely;
re-queuing data for reprocessing by one or more of said acts, in accordance with the status of said one or more acts prior to when it ceased performing its intended functions; and
restarting said one or more acts to reprocess said re-queued data.

20. The method of claim 12 wherein said act of receiving comprises:
storing said plurality of text documents and at least one control file associated with said plurality of text documents in an input data storage unit;
processing said at least one control file so as to validate its control file structure and check for at least one referenced data file containing data from at least one of said plurality of text documents;
copying said at least one data file to a second data storage unit;
creating at least one processing control file; and
thereafter, deleting said plurality of text documents and said at least one control file from said input data storage unit.

21. The method of claim 20 wherein said act of converting said plurality of text documents comprises detecting a file type for said at least one data file, initiating appropriate conversion routines for said at least one data file depending on said detected file type so as to convert said at least one data file into a standard format, and creating said at least one processing control file and at least one new data file, in accordance with said standard format, for further processing.

22. The method of claim 12 wherein said act of converting said extracted information comprises:
converting said extracted information to a XDR-compliant data format: and
converting said XDR-compliant data to a desired end-user-compliant format.

23. A system for extracting information from a plurality of text documents, comprising:
means for receiving a plurality of text documents for information extraction, wherein said plurality of documents may be formatted in accordance with any one of a plurality of formats;
means for converting said plurality of text documents into a single format for processing;
means for generating and assigning tokens to symbols contained in said plurality of text documents;
means for extracting desired information from each of said plurality of text documents based in part on said token assignments;
means for converting said extracted information into a single output format; and
means for outputting the converted information, wherein each of the above means operate simultaneous and independently of one another so as to process said plurality of text documents in a pipeline fashion.

24. The system of claim 23 wherein said means for extracting comprises means for finding a best path sequence of states in a [MM, wherein said HMM is trained using a plurality of training documents each having a sequence of tagged states, and wherein said information is extracted from said plurality of text documents based on said best path sequence of states provided by said HMM for each of said plurality of text documents.

25. The system of claim 24 wherein said means for extracting further comprises means for calculating a confidence score for information extracted from at least one of said plurality of text documents, wherein said confidence score is based on a measure of similarity between said best path sequence of states and at least one of said sequence of tagged states from at least one of said plurality of training documents.

26. The system of claim 25 wherein said measure of similarity is based in part on an edit distance between said best path sequence of states and at least one of said sequence of tagged states from at least one of said plurality of training documents.

27. The system of claim 25 wherein said HMM is a hierarchical HMM (HHMM) comprising at least one subsequence of states within at least one of said states in said best path sequence of states and said means for calculating a confidence score comprises means for calculating values of edit distance between said best path sequence of states, including said at least one subsequence of states, and said at least one sequence of tagged states, wherein said means for calculating edit distance values comprises means for scaling an edit distance value associated with said at least one subsequence of states by a specified cost factor.

28. The system of claim 24 wherein said HMM comprises at least one merged state formed by V-merging, at least one merged stated formed by H-merging, and at least one merged sequence of states formed by ESS-merging.

29. The system of claim 24 wherein said HMM states are modeled with non-exponential length distributions, and wherein said system further comprises means for dynamically adjusting a probability length distribution for each of said states during information extraction, wherein if a first state's best transition was from itself, its self-transition probability is adjusted to (1−cdf(t+1))/(1−cdf(t)) and all other outgoing transitions from said first state are scaled by (cdf(t+1)−cdf(t))/(1−cdf(t)), and if said first state is transitioned to by another state, its self-transition probability is reset to its original value of (1−cdf(1))/(1−cdf(0)), where cdf is the cumulative probability distribution function for said first state's length distribution, and t is the number of symbols emitted by said first state in said best path.

30. The system of claim 23 further comprising:
means for monitoring the performance of each of said means recited in claim 23 and detecting if one or more of said means recited in claim 23, ceases to operate prematurely;
means for re-queuing data for reprocessing by one or more of said means recited in claim 23, in accordance with the status of said one or more means recited in claim 23 prior to when it ceased operating prematurely; and
means for restarting said one or more means recited in claim 23 to reprocess said re-queued data.

31. The system of claim 23 wherein said means for receiving comprises:
means for storing said plurality of text documents and at least one control file associated with said plurality of text documents in an input data storage unit;
means for processing said at least one control file so as to validate its control file structure and check for at least one referenced data file containing data from at least one of said plurality of text documents;
means for copying said at least one data file to a second data storage unit;
means for creating at least one processing control file; and
means for deleting said plurality of text documents and said at least one control file from said input data storage unit.

32. The system of claim 31 wherein said means for converting said plurality of text documents comprises:
means for detecting a file type for said at least one data file;
means for initiating an appropriate conversion routine for said at least one data file depending on said detected file type so as to convert said at least one data file into a standard format; and
means for creating said at least one processing control file and at least one new data file, in accordance with said standard format, for further processing.

33. The system of claim 23 wherein said means for converting said extracted information comprises:
means for converting said extracted information to a XDR-compliant data format: and
means for converting said XDR compliant data to a desired end-user-compliant format.

34. A computer-readable medium having computer executable instructions for performing a method of extracting information from a plurality of text documents, the method comprising:
receiving a plurality of text documents for information extraction, wherein said plurality of documents may be formatted in accordance with any one of a plurality of formats;
converting said plurality of text documents into a single format for processing;
generating and assigning tokens to symbols contained in said plurality of text documents;
extracting desired information from each of said plurality of text documents based in part on said token assignments;
converting said extracted information into a single output format; and
outputting the converted information, wherein each of the above acts are performed simultaneous and independently of one another so as to process said plurality of text documents in a pipeline fashion.

35. The computer-readable medium of claim 34 wherein said act of extracting comprises finding a best path sequence of states in a HMM, wherein said HMM is trained using a plurality of training documents each having a sequence of tagged states, and wherein said information is extracted from said plurality of text documents based on a best path sequence of states provided by said HMM for each of said plurality of text documents.

36. The computer-readable medium of claim 35 wherein said act of extracting further comprises calculating a confidence score for information extracted from at least one of said plurality of text documents, wherein said confidence score is based on a measure of similarity between said best path sequence of states and at least one of said sequence of tagged states from at least one of said plurality of training documents.

37. The computer-readable medium of claim 36 wherein said measure of similarity is based in part on an edit distance between said best path sequence of states and at least one of said sequence of tagged states from at least one of said plurality of training documents.

38. The computer-readable medium of claim 36 wherein said HMM is a hierarchical HMM (HHMM) comprising at least one subsequence of states within at least one of said states in said best path sequence of states and said confidence score is calculated using values of edit distance between said best path sequence of states, including said at least one subsequence of states, and said at least one sequence of tagged states, wherein said edit distance value associated with said at least one subsequence of states is scaled by a specified cost factor.

39. The computer-readable medium of claim 35 wherein said HMM comprises at least one merged state formed by V-merging, at least one merged stated formed by H-merging, and at least one merged sequence of states formed by ESS-merging.

40. The computer-readable medium of claim 35 wherein said HMM states are modeled with non-exponential length distributions and said act of extracting further comprises dynamically changing probability length distributions of said HMM states during information extraction, wherein if a first state's best transition was from itself, its self-transition probability is adjusted to (1−cdf(t+1))/(1−cdf(t)) and all other outgoing transitions from said first state are scaled by (cdf(t+1)−cdf(t))/(1−cdf(t)), and if said first state is transitioned to by another state, its self-transition probability is reset to its original value of (1−cdf(1))/(1−cdf(0)), where cdf is the cumulative probability distribution function for said first state's length distribution, and t is the number of symbols emitted by said first state in said best path.

41. The computer-readable medium of claim 34 wherein said method further comprises:
monitoring the performance of each of said acts recited in claim 34 and detecting if one or more of said acts recited in claim 34, ceases to perform prematurely;
re-queuing data for reprocessing by one or more of said acts, in accordance with the status of said one or more acts prior to when it ceased performing its intended functions; and
restarting said one or more acts to reprocess said re-queued data.

42. The computer-readable medium of claim 34 wherein said act of receiving comprises:
storing said plurality of text documents and at least one control file associated with said plurality of text documents in an input data storage unit;
processing said at least one control file so as to validate its control file structure and check for at least one referenced data file containing data from at least one of said plurality of text documents;
copying said at least one data file to a second data storage unit;
creating at least one processing control file; and
thereafter, deleting said plurality of text documents and said at least one control file from said input data storage unit.

43. The computer-readable medium of claim 42 wherein said act of converting said plurality of text documents comprises detecting a file type for said at least one data file, initiating appropriate conversion routines for said at least one data file depending on said detected file type so as to convert said at least one data file into a standard format, and creating said at least one processing control file and at least one new data file, in accordance with said standard format, for further processing.

44. The computer-readable medium of claim 34 wherein said act of converting said extracted information comprises:
converting said extracted information to a XDR-compliant data format: and
converting said XDR-compliant data to a desired end-user-compliant format.

45. A method of extracting information from a text document, comprising:
finding a best path sequence of states in a HMM, wherein said HMM is trained using a plurality of training documents each having a sequence of tagged states;
extracting information from said text document based on said best path sequence of states; and
calculating a confidence score for said extracted information, wherein said confidence score is based on a measure of similarity between said best path sequence of states and at least one of said sequence of tagged states from at least one of said plurality of training documents.

46. The method of claim 45 wherein said measure of similarity is based in part on an edit distance between said best path sequence of states and at least one of said sequence of tagged states from at least one of said plurality of training documents.

47. The method of claim 45 wherein said HMM comprises at least one merged state formed by V-merging, at least one merged stated formed by H-merging, and at least one merged sequence of states formed by ESS-merging.

48. The method of claim 45 wherein said HMM is a hierarchical HMM (HHMM) comprising at least one subsequence of states within at least one of said states in said best path sequence of states and said confidence score is calculated using values of edit distance between said best path sequence of states, including said at least one subsequence of states, and said at least one sequence of tagged states, wherein said edit distance value associated with said at least one subsequence of states is scaled by a specified cost factor.

49. A method of extracting information from a text document, comprising:
finding a best path sequence of states in a HMM, wherein said IBMM is trained using a plurality of training documents each having a sequence of tagged states and said HMM states are modeled with non-exponential length distributions so as to allow their probability length distributions to be changed dynamically during information extraction; and
extracting information from said text document based on said best path sequence of states, wherein if a first state's best transition was from itself, its self-transition probability is adjusted to (1−cdf(t+1))/(1−cdf(t)) and all other outgoing transitions from said first state are scaled by (cdf(t+1)−cdf(t))/(1−cdf(t)), and if said first state is transitioned to by another state, its self-transition probability is reset to its original value of (1−cdf(1))/(1−cdf(0)), where cdf is the cumulative probability distribution function for said first state's length distribution, and t is the number of symbols emitted by said first state in said best path.

50. A computer-readable medium having computer executable instructions for performing a method of extracting information from a text document, said method comprising:
finding a best path sequence of states in a HMM, wherein said HMM is trained using a plurality of training documents each having a sequence of tagged states;
extracting information from said text document based on said best path sequence of states; and
calculating a confidence score for said extracted information, wherein said confidence score is based on a measure of similarity between said best path sequence of states and at least one of said sequence of tagged states from at least one of said plurality of training documents.

51. The computer-readable medium of claim 50 wherein said measure of similarity is based in part on an edit distance between said best path sequence of states and at least one of said sequence of tagged states from at least one of said plurality of training documents.

52. The computer-readable medium of claim 50 wherein said HMM comprises at least one merged state formed by V-merging, at least one merged stated formed by H-merging, and at least one merged sequence of states formed by ESS-merging.

53. The computer-readable medium of claim 50 wherein said HMM is a hierarchical HMM (HHMM) comprising at least one subsequence of states within at least one of said states in said best path sequence of states and said confidence score is calculated using values of edit distance between said best path sequence of states, including said at least one subsequence of states, and said at least one sequence of tagged states, wherein said edit distance value associated with said at least one subsequence of states is scaled by a specified cost factor.

54. A computer-readable medium having computer executable instructions for performing a method of extracting information from a text document, said method comprising:
finding a best path sequence of states in a HMM, wherein said HMM is trained using a plurality of training documents each having a sequence of tagged states and said HMM states are modeled with non-exponential length distributions so as to allow their probability length distributions to be changed dynamically during information extraction; and
extracting information from said text document based on said best path sequence of states, wherein if a first HMM state's best transition was from itself, its self-transition probability is adjusted to (1−cdf(t+1))/(1−cdf(t)) and all other outgoing transitions from said first HMM state are scaled by (cdf(t+1)−cdf(t))/(1−cdf(t)), and if said first HMM state is transitioned to by another state, its self-transition probability is reset to its original value of (1−cdf(1))/(1−cdf(0)), where cdf is the cumulative probability distribution function for said first state's length distribution, and t is the number of symbols emitted by said first state in said best path.

55. A method of extracting information from a text document, comprising:
creating a HMM using a plurality of training documents of a known type, wherein said training documents comprise tagged sequences of states;
generalizing said HMM by merging repeating sequences of states;
finding a best path through said HMM representative of said text document, wherein information is extracted from said text document based on said best path.

56. A method of extracting information from a text document, comprising:
creating a HMM using a plurality of training documents of a known type, wherein said training documents comprise tagged sequences of states and said HMM comprises HMM states that are modeled with non-exponential length distributions so as to allow their probability length distributions to be changed dynamically during information extraction;
finding a best path through said HMM representative of said text document, wherein information is extracted from said text document based on said best path, and wherein if a first HMM state's best transition was from itself, its self-transition probability is adjusted to (1−cdf(t+1))/(1−cdf(t)) and all other outgoing transitions from said first HMM state are scaled by (cdf(t+1)−cdf(t))/(1−cdf(t)), and if said first HMM state is transitioned to by another state, its self-transition probability is reset to its original value of (1−cdf(1))/(1−cdf(0)), where cdf is the cumulative probability distribution function for said first state's length distribution, and t is the number of symbols emitted by said first state in said best path.

57. A computer-readable medium having computer executable instructions for performing a method of extracting information from a text document, said method comprising:
creating a HMM using a plurality of training documents of a known type, wherein said training documents comprise tagged sequences of states;
generalizing said HMM by merging repeating sequences of states;
finding a best path through said HMM representative of said text document, wherein information is extracted from said text document based on said best path.

58. A computer-readable medium having computer executable instructions for performing a method of extracting information from a text document, said method comprising:
creating a HMM using a plurality of training documents of a known type, wherein said training documents comprise tagged sequences of states and said HMM comprises HMM states that are modeled with non-exponential length distributions so as to allow their probability length distributions to be changed dynamically during information extraction;
finding a best path through said HMM representative of said text document, wherein information is extracted from said text document based on said best path, and wherein if a first HMM state's best transition was from itself, its self-transition probability is adjusted to (1−cdf(t+1))/(1−cdf(t)) and all other outgoing transitions from said first HMM state are scaled by (cdf(t+1)−cdf(t))/(1−cdf(t)), and if said first HMM state is transitioned to by another state, its self-transition probability is reset to its original value of (1−cdf(1))/(1−cdf(0)), where cdf is the cumulative probability distribution function for said first state's length distribution, and t is the number of symbols emitted by said first state in said best path.

59. A computer readable storage medium encoded with information comprising a HMM data structure including a plurality of states in which at least one sequence of states in said HMM data structure is created by merging a repeated sequence of states.

60. A computer readable storage medium encoded with information comprising a HMM data structure including a plurality of states in which at least one sequence of more than two states in said HMM data structure includes a transition from a last state in the at least one sequence to the first state in the sequence.
